(19) United States
(12) Patent Application Publication
(10) Pub. No.: US 2006/0120405 A1
(43) Pub. Date: Jun. 8, 2006

(54) Method and apparatus for intermediate buffer segmentation and reassembly

(76) Inventor: Antonius Engbersen, Feusisberg (CH)

Correspondence Address: LOUIS PAUL HERZBERG, 3 CLOVERDALE LANE, MONSEY, NY, 10952, US

(21) Appl. No.: 10/535,966

(22) PCT Filed: Nov. 5, 2003
(86) PCT No.: PCT/IB03/05016

§ 371 Date: Oct. 19, 2005

(30) Foreign Application Priority Data
Nov. 25, 2002 (EP) 02406015.4

(51) Int. Cl. H04J 3/24

(52) U.S. Cl. 370/473

(57) ABSTRACT

The present invention discloses a method and apparatus for transmitting incoming packet data via a data bus to a memory unit and transmitting outgoing packet data from the memory unit to a communication link via the data bus. The method for transmitting packet data via a data bus to a memory unit comprises the steps of receiving a stream of packet data; storing the received packet data in a buffer unit; and in response to the stored packet data, transmitting a burst of packet data to the memory unit, wherein the size of the burst of packet data depends on the properties of the data bus. The method for transmitting outgoing packet data from a memory unit to a communication link via a data bus comprises the steps of transmitting a burst of packet data from the memory unit to a buffer unit, wherein the size of the burst of packet data depends on the properties of the data bus; storing the packet data in the buffer unit; segmenting the packet data in the buffer; and in response to the transmission step, sending the segmented packet data to the communication link.

### TECHNICAL FIELD

The present invention is related to a method and apparatus for transmitting incoming packet data via a data bus to a memory unit. Moreover, the invention is also related to a method and apparatus for transmitting outgoing packet data from a memory unit to a communication link via a data bus.

### BACKGROUND OF THE INVENTION

Almost all communication protocols, with ATM (Asynchronous Transfer Protocol) or TCP/IP (Transmission Control Protocol/Internet Protocol) as most well known representants of this category, segment and reassemble user data packets for efficient communication. In most cases, the segmentation and reassembly is done transparent to the user (or application) between the application memory and the communication medium. Basically two extremes are known:

1.) Segmentation and reassembly is performed directly from and to the application (‘host’) memory;

2.) Application packets are transferred from ‘host’ memory to communication-adapter memory, and segmentation and reassembly is performed between adapter-memory and the communication medium.

Both extremes have some significant disadvantages that is either they cause a large load on the host processor bus bogging the host computational throughput down or they require a substantial amount of additional memory on a network interface card, which is additional cost.

In more detail, in 1.) an ATM cell payload, which is relatively small, 48 bytes at most, is transferred over a system bus, causing significant overhead in this transfer. On a 64-bit PCI bus (Peripheral Component Interconnect bus) for example, 6-cycles are sufficient to transfer the 48-byte payload, and additionally, in the best case, 1 address cycle and one ‘burst-end’ cycle are applied resulting in 8 cycles, which causes 25% overhead. In 2.) the adapter memory is both costly and limited. A limited amount of memory limits the number of concurrent connections being supported, and the fact that the memory is ‘in use’ as long as an application packet arrives, can cause significant memory requirements: for 1000 connections, with an average application packet size of 2 Kbyte, more than 2 Mbyte of reassembly memory is required to cope with the worst case. Otherwise, complex algorithms have to be developed and implemented to prevent deadlock. The required throughput of this memory also makes it expensive. At the same time, an virtually infinite source of ‘host’ memory is available in the system, but not used.

In U.S. Pat. No. 5,303,302 is described a network controller that receives encrypted data packets in the form of interleaved streams of cells, and stores the received cells in a buffer until the end of each packet is received, at which time the complete packet is decrypted, error checked, and then transmitted to a host computer. A packet is thus fully reassembled in. an off-host processor memory, decrypted, and then send to the host memory via a Direct-Memory Access (DMA) mechanism.

Many known system buses in computer systems are not optimal used for the transfer of packets. This is particularly disadvantageous when more and more concurrent connections with smaller average packet sizes are used.

From the above it follows that there is still a need in the art for an improved transfer of packets in a computer system in order to reduce bus-overhead and to achieve optimal cost/performance solutions.

Future on-chip solutions should allow to share the transmit and the receive memory dynamically, thereby increasing the throughput.

### SUMMARY AND ADVANTAGES OF THE INVENTION

In general, a buffer unit, that is contemplated as an on-adapter memory, allows a segmentation and/or reassembly, e.g. of 256 byte or 512 byte blocks of data. As soon as the buffer unit has transmitted or received 256 bytes of packet data, for example, a new burst of packet data of 256 byte is requested from or send to a memory unit, also referred to as application memory. The application memory can be the main memory or the cache in a computer system. The memory unit usually uses 256 or 512 byte blocks of data. The 256 or 512 byte blocks of data are contemplated as a unit of transfer between application memory and communication-adapter memory, and at the same time this forms the basis of the packet data size which has to be taken into consideration when computing the performance of the buffer unit, i.e. the on-adapter memory.

In accordance with the present invention, there is provided a method for transmitting packet data via a data bus to a memory unit. The method comprises the steps of receiving a stream of packet data; storing the received packet data in a buffer unit; and in response to the stored packet data, transmitting a burst of packet data to the memory unit, wherein the size of the burst of packet data depends on the properties of the data bus.

In accordance with a second aspect of the present invention, there is provided a method for transmitting outgoing packet data from a memory unit to a communication link via a data bus. The method comprises the steps of transmitting a burst of packet data from the memory unit to a buffer unit, wherein the size of the burst of packet data depends on the properties of the data bus; storing the packet data in the buffer unit; and in response to the transmission step, sending the stored and when useful segmented packet data to the communication link.

The received packet data can be sorted in the buffer unit, which has the advantage that the data is presorted already in the buffer unit and the assembly to a message later on in the memory unit can be performed more efficiently. This is further supported when the transmission of the burst of packet data comprises the sorted packet data already.

When the burst of packet data to be transmitted via the data bus corresponds to the size as allowed by a data bus operation, then the advantage occurs that an optimal amount of packet data can be transferred within a transfer cycle.

The transmission of outgoing packet data from the memory unit to the communication link via the data bus can comprise the step of segmenting the packet data in the buffer unit. Thus, the transmission step can comprise sending the segmented packet data to the communication link. Generally, the packet data arriving via the data bus is segmented in the buffer unit into smaller blocks suitable to be sent to the communication link. This allows to decouple the segmentation from the memory unit.

In accordance with a third aspect of the present invention, there is provided an apparatus for transmitting packet data via a data bus to a memory unit. The apparatus comprises receiving means for receiving a stream of the packet data; a buffer unit for storing the received packet data; and a control unit that in response to the stored packet data initiates the transmission of a burst of packet data from the buffer unit to the memory unit, wherein the size of the burst of packet data depends on the properties of the data bus.

In accordance with a fourth aspect of the present invention, there is provided an apparatus for transmitting outgoing packet data to a communication link. The apparatus comprises a memory unit providing the outgoing packet data; a buffer unit for storing the packet data; a data bus coupling the memory unit to the buffer unit; and a control unit that in operation accesses the data bus, initiates the transfer of a burst of packet data from the memory unit to the buffer unit, and responsive to the transfer provokes the transmission of the stored and when necessary segmented packet data from the buffer unit to the communication link, wherein the size of the burst of packet data depends on the properties of the data bus.

The buffer unit can comprise sorting means for sorting the packet data arriving interleaved. This can be implemented by a multiplexer and queues which store temporally the packet data forming part of a message or packet.

The buffer unit can be adapted to segment and reassemble the packet data. This has the advantage that incoming and outgoing packet data can be processed by the same unit and therefore controlled by one control unit efficiently.

The control unit can comprise a buffer-unit controller and a memory controller. These units allow an independent control of the buffer unit and the access of the memory unit. In particular, the buffer-unit controller can control the sorting, reassembly, and/or the segmentation of the packet data.

The proposed solution reduces the requirement of on-adapter memory, to such a level that a single-chip implementation of e.g. DRAM and logic on a chip becomes possible with today technology.

Moreover, the bus-overhead can be reduced from 25% to approximate 6% (256 byte) or 3% (512 byte).

It will become simpler to support more concurrent connections because of the smaller average packet data or packet size, and, because an on-chip DRAM solution allows to share the transmit and the receive memory dynamically, an improved usage of this memory is obtained, and thus increased throughput at same cost.

For the effective design of 622 Mbps ATM (Asynchronous Transfer Protocol) Segmentation/Reassembly (SAR) adapters, the desired efficiency and total throughput of a shared memory, (4*622 Mbps) an on-chip DRAM solution is realizable with the proposed solution. Thus, an optimal cost and performance ratio is achievable.

### DESCRIPTION OF THE DRAWINGS

A preferred embodiment of the invention is described in detail below, by way of example only, with reference to the following schematic drawings.

FIG. 1 shows a schematic illustration of an embodiment of the invention.

FIG. 2 shows a buffer unit in more detail.

The drawings are provided for illustrative purposes only.

### DETAILED DESCRIPTION OF AN EMBODIMENT

Before an embodiment is described in detail with reference to the figures, some general issues are addressed.

First there is the fact that every host computer system has an optimal memory-block transfer size, which is very often in the order of one or multiple cache-lines: say multiples of 32 bytes. Every bus transfer has a fixed overhead of addressing cycles and possibly other parameters which are to be transferred first. The number of fixed bus or addressing cycles to set up a data transfer and the maximum data bus length are properties of the data bus. The relationship thereof describes the efficiency of the data bus. An optimal efficiency is therefore achieved if the number or length of packet data is identical or nearly similar to the maximum data bus length. The efficiency is decreasing when smaller packet data is transmitted and becomes even worse if the fixed overhead of addressing cycles is large compared to the actual packet data to be transferred.

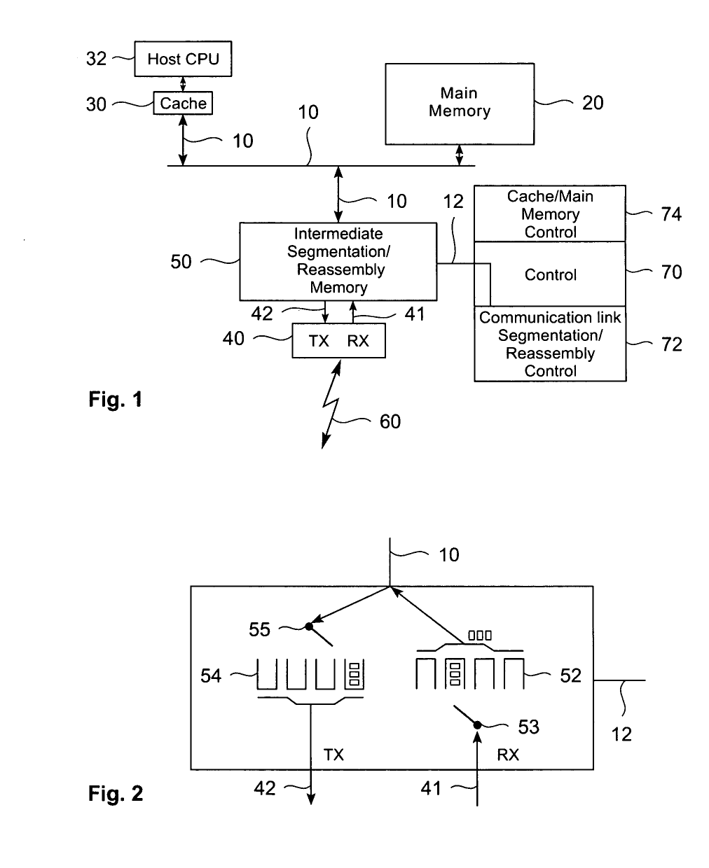

FIG. 1 shows a schematic illustration of an arrangement for transmitting incoming and outgoing packet data via a data bus 10 that is also referred to as system bus 10. The term “packet data” refers herein to information that forms part of a packet, also referred to as variable-length packet, or a cell that usually is a fixed-length information. The arrangement is part of a computer system and comprises receiving means 40 for receiving a stream of the packet data from a communication link 60 and a buffer unit 50, also referred to as intermediate segmentation and reassembly memory, for storing the received packet data, which unit 50 is coupled to the receiving means 40 via a receive line 41 and a transmit line 42. The receiving means 40 can be implemented as a transceiver 40 to support the receiving (RX) from and transmitting (TX) to the communication link 60. The arrangement comprises further a main memory 20, also referred to as main storage 20, and a cache 30 coupled to a host CPU or processor 32. Both, the main memory 20 and the cache 30 are connected to the data bus 10 to which also the buffer unit 50 is connected. A control unit 70 connected to the buffer unit 50 via a control line 12 is further provided and comprises a buffer-unit controller 72 and a memory controller 74. It controls the buffer-unit controller 72 and the memory controller 74 in such a way that an optimal interaction between the buffer unit 50 and the main memory 20 or cache 30 is achievable. Further, the buffer-unit controller 72 controls the buffer unit 50 and the memory controller 74 the access to the main memory 20 and the cache 30 via the data bus 10.

In response to the stored and reassembled packet data in the buffer unit 50, i.e. the number of stored or sorted packet data, the control unit 70 initiates the transmission of a burst of packet data from the buffer unit 50 to the main memory 20 or the cache 30, respectively. The size of the burst of the packet data thereby depends on the properties of the data bus 10. The properties of the data bus 10 are contemplated as the maximum data bus length and the number of fixed bus cycles to set up a data transfer.

For outgoing packet data where the packet data is advantageously segmented in the buffer unit 50 before the transmission to the communication link 60, the control unit 70 accesses the data bus 10, initiates the transfer of a burst of packet data from the main memory 20 or the cache 30 to the buffer unit 50, and responsive to the transfer provokes the transmission of the segmented packet data from the buffer unit 50 to the communication link 60 via the transceiver 40. Thereby the size of the burst of packet data depends on the properties of the data bus 10.

The system operates as follows. Packet data, which are part of messages, and here one can think of multiple TCP/IP packets which make up a message, or multiple ATM cells which make up a data packet, arrive on the communication link 60, normally in such a way that packets or cells comprising the packet data which belong to multiple different messages are interleaved. In order to assemble the full message, on which the CPU 32 will act, multiple packet data has to be reassembled into a message. The buffer-unit controller 72, which is contemplated as a communication link reassembly control, is responsible to combine multiple packets or packet data into a message. It uses the buffer unit 50 as intermediate segmentation and reassembly memory to perform this. The control unit 70 will, depending on the optimal size of data-transfer between the buffer unit 50 and the main memory 20 or the cache 30 of the host CPU 32, instruct the memory controller 74 that acts as a Cache/Main memory control unit to move a piece of data of the appropriate size, which is usually larger then one packet, to the main memory 20 or the cache 30, and after completion of this transfer it will release the memory in the buffer unit 50 again for use by the buffer-unit controller 72. For those skilled in the art, it is clear that this can occur without the buffer-unit controller 72, thereby allowing a decoupling between the packet-size on the communication link 60 and the packet data transfer size between the buffer unit 50 and the main memory 20 or cache 30. The optimal data transfer size between the cache 30 and main memory 20 could even be different, and the control unit 70 could apply a different strategy depending on whether the message shall be delivered into the main memory 20 or the cache 30. The optimal size corresponding to the burst of packet data is herein called a chunk. Once the buffer-unit controller 72 has detected an end-of-message indicator, the control unit 70 instructs to transfer the remaining packet data from the buffer unit 50 to the main memory 20 or the cache 30 - to prevent that the last part of a message “sticks” in the buffer unit 50.

For messages leaving the system, i.e. being send out on the communication link 60, the CPU 32 will initiate a transfer to move the packet data of the message from the main memory 20 or the cache 30 to the communication link 60 by instructing the memory controller 74 to perform this. The control unit 70 will take control of this and move an optimal chunk into the buffer unit 50 and instruct the buffer-unit controller 72 to start segmenting the chunk and send out packets. Once a piece of the chunk has been transmitted, the control unit 70 will initiate the transfer of the next chunk.

The described system achieves a decoupling of the communication link packet and message sizes from the optimal chunk size for packet data transfer in the host CPU system, thereby allowing engineers skilled in the art to determine the optimal size of the chunk, the buffer unit 50, i.e. the intermediate segmentation and reassembly memory, and the system performance.

FIG. 2 shows the buffer unit 50 or intermediate segmentation and reassembly memory in more detail. The same reference numbers are used to denote the same or like parts. The buffer unit 50 is able to segment and reassemble the packet data. For that, the buffer unit 50 comprises sorting means 52 for sorting the packet data arriving interleaved via the receive line 41 from the transceiver 40. The sorting means 52 comprises several input queues 52 and an input distributor 53 that can be a multiplexer for distributing the received packet data via the RX channel to the respective queues 52. The sorting of the incoming packet data to the respective input queues 52 is controlled by the control unit 70, and more particularly by the buffer-unit controller 72, via the control line 12. For the outgoing packet data, the buffer unit 50 further comprises output queues 54 together with an output multiplexer 55. The packet data is segmented under control of the buffer-unit controller 72 and then sent to the transceiver 40 via the transmit line 42, also labeled with TX. The segmentation as well as the transfer to the transceiver 40 of the outgoing packet data is generally controlled by the control unit 70.

What is claimed is:

1. A method for transmitting packet data via a data bus to a memory unit, the method comprising the steps of:
receiving a stream of packet data;
storing the received packet data in a buffer unit; and
in response to the stored packet data, transmitting a burst of packet data to the memory unit, wherein the size of the burst of packet data depends on the properties of the data bus and the burst of packet data to be transmitted corresponds to the size as allowed by a data bus operation.

2. The method according to claim 1, further comprising sorting the packet data in the buffer unit.

3. The method according to claim 2, wherein in the step of transmitting the burst of packet data comprises the sorted packet data.

4. A method for transmitting outgoing packet data from a memory unit to a communication link via a data bus, the method comprising the steps of:
transmitting a burst of packet data from the memory unit to a buffer unit, wherein the size of the burst of packet data depends on the properties of the data bus and the burst of packet data to be transmitted corresponds to the size as allowed by a data bus operation;
storing the packet data in the buffer unit; and
in response to the transmission step, sending the stored packet data to the communication link.

5. The method according to claim 4, further comprising segmenting the packet data in the buffer unit.

6. An apparatus for transmitting packet data via a data bus (10) to a memory unit, the apparatus comprising:
receiving means for receiving a stream of the packet data;
a buffer unit for storing the received packet data; and
a control unit that in response to the stored packet data initiates the transmission of a burst of packet data from the buffer unit to the memory unit, wherein the size of the burst of packet data depends on the properties of the data bus and the burst of packet data to be transmitted corresponds to the size as allowed by a data bus operation.

7. The apparatus according to claim 6, wherein the buffer unit comprises sorting means for sorting the packet data arriving interleaved.

8. The apparatus according to claim 6, wherein the buffer unit is adapted to reassemble the packet data.

9. An apparatus for transmitting outgoing packet data to a communication link, the apparatus comprising:
a memory unit providing the outgoing packet data;
a buffer unit for storing the packet data;
a data bus coupling the memory unit to the buffer unit; and
a control unit that in operation accesses the data bus (10), initiates the transfer of a burst of packet data from the memory unit to the buffer unit, and responsive to the transfer provokes the transmission of the stored packet data from the buffer unit to the communication link, wherein the size of the burst of packet data depends on the properties of the data bus and the burst of packet data to be transmitted corresponds to the size as allowed by a data bus operation.

10. The apparatus according to claim 6, wherein the control unit comprises a buffer-unit controller for reassembling and/or segmentation of the packet data.

11. The apparatus according to claim 6, wherein the control unit comprises a memory controller for controlling the access to the memory unit.

12. A computer system comprising an apparatus according to claim 6.

13. An article of manufacture comprising a computer usable medium having computer readable program code means embodied therein for causing transmission of packet data via a data bus to a memory unit, the computer readable program code means in said article of manufacture comprising computer readable program code means for causing a computer to effect the steps of claim 1.

14. A program storage device readable by machine, tangibly embodying a program of instructions executable by the machine to perform method steps for transmitting packet data via a data bus to a memory unit, said method steps comprising the steps of claim 1.

15. An article of manufacture comprising a computer usable medium having computer readable program code means embodied therein for causing transmitting outgoing packet data from a memory unit to a communication link via a data bus, the computer readable program code means in said article of manufacture comprising computer readable program code means for causing a computer to effect the steps of claim 4.

16. A program storage device readable by machine, tangibly embodying a program of instructions executable by the machine to perform method steps for transmitting outgoing packet data from a memory unit to a communication link via a data bus, said method steps comprising the steps of claim 4.

17. A computer program product comprising a computer usable medium having computer readable program code means embodied therein for causing transmission of packet data via a data bus to a memory unit, the computer readable program code means in said computer program product comprising computer readable program code means for causing a computer to effect the functions of claim 6.

18. A computer program product comprising a computer usable medium having computer readable program code means embodied therein for causing transmission of outgoing packet data to a communication link, the computer readable program code means in said computer program product comprising computer readable program code means for causing a computer to effect the functions of claim 9.

19. An article of manufacture comprising a computer usable medium having computer readable program code means embodied therein for causing transmission of packet data via a data bus to a memory unit, the computer readable program code means in said article of manufacture comprising computer readable program code means for causing a computer to effect the steps of claim 2.

20. A computer program product comprising a computer usable medium having computer readable program code means embodied therein for causing transmission of packet data via a data bus to a memory unit, the computer readable program code means in said computer program product comprising computer readable program code means for causing a computer to effect the functions of claim 10.
